(19) United States
(12) Patent Application Publication
(10) Pub. No.: US 2026/0258714 A1
(43) Pub. Date: Sep. 3, 2026

(54) METHOD FOR OPTIMIZING CARBON DIOXIDE SEQUESTRATION

(71) Applicant: Schlumberger Technology Corporation, Sugar Land, TX (US)

(72) Inventors: Damilola Ogunlana, Houston, TX (US); Ibrahim El-sayed, Houston, TX (US)

(21) Appl. No.: 19/549,186

(22) Filed: Feb. 25, 2026

Related U.S. Application Data
(60) Provisional application No. 63/764,793, filed on Feb. 28, 2025.

(51) Int. Cl. E21B 41/00

(52) U.S. Cl. CPC E21B 41/0064

(57) ABSTRACT

A method for optimizing carbon dioxide injection volumes. The method may include inputting a plurality of starting parameters, defining an area of review (AOR) related to a CO2 sequestration site based on the starting parameters, injecting CO2 into the defined AOR, detecting when a boundary of the AOR has been exceeded by the injected CO2, adjusting a flow of CO2 injected into the AOR when the boundary of the AOR has been exceeded by the injected CO2, and determining an optimal volume of CO2 to be injected into the AOR based on the adjusted flow. The optimal volume of CO2 may be based on a pressure plume of the CO2 injected into the AOR, a CO2 plume of the CO2 injected into the AOR, or a combination thereof.

### CROSS-REFERENCE TO RELATED APPLICATIONS

This application claims priority to U.S. Provisional Patent Application No. 63/764,793 filed on February 28, 2025, which is incorporated by reference.

### BACKGROUND

Carbon sequestration or carbon storage is the process by which CO2 is deposited into a subsurface or other underground geological feature. The CO2 may be pressurized until becoming a liquid so that it may be injected into the subsurface where it can then be absorbed and contained by porous rock or other geological features. What is needed is a system and method for optimizing carbon dioxide sequestration.

### SUMMARY

According to certain embodiments, a method may be provided for optimizing carbon dioxide injection volumes. The method may include inputting a plurality of starting parameters, defining an area of review (AOR) related to a CO2 sequestration site based on the starting parameters, injecting CO2 into the defined AOR, detecting when a boundary of the AOR has been exceeded by the injected CO2, adjusting a flow of CO2 injected into the AOR when the boundary of the AOR has been exceeded by the injected CO2, and determining an optimal volume of CO2 to be injected into the AOR based on the adjusted flow.

In certain embodiments, a computing system may be provided which may include one or more processors and a memory system having one or more non-transitory computer-readable media storing instructions that, when executed by at least one of the one or more processors, cause the computing system to perform operations. The operations may include inputting a plurality of starting parameters, defining an area of review (AOR) related to a CO2 sequestration site based on the starting parameters, injecting CO2 into the defined AOR, detecting when a boundary of the AOR has been exceeded by the injected CO2, adjusting a flow of CO2 injected into the AOR when the boundary of the AOR has been exceeded by the injected CO2, and determining an optimal volume of CO2 to be injected into the AOR based on the adjusted flow.

In certain embodiments, a non-transitory computer-readable medium storing instructions may be provided that, when executed by one or more processors of a computing system, cause the computing system to perform operations. The operations may include inputting a plurality of starting parameters, defining an area of review (AOR) related to a CO2 sequestration site based on the starting parameters, injecting CO2 into the defined AOR, detecting when a boundary of the AOR has been exceeded by the injected CO2, adjusting a flow of CO2 injected into the AOR when the boundary of the AOR has been exceeded by the injected CO2, and determining an optimal volume of CO2 to be injected into the AOR based on the adjusted flow.

### BRIEF DESCRIPTION OF THE DRAWINGS

The accompanying drawings, which are incorporated in and constitute a part of this specification, illustrate embodiments of the present teachings and together with the description, serve to explain the principles of the present teachings. In the figures:

FIG. 1 illustrates an example of a system that includes various management components to manage various aspects of a geologic environment, according to an embodiment.

FIG. 2 illustrates an aerial view of outer and inner boundaries of a pressure plume and a CO2 plume, respectively, according to an embodiment.

FIG. 3 illustrates a 3D view of a pressure boundary for all injection target intervals including four injection wells, according to an embodiment.

FIG. 4 illustrates a 3D view of a CO2 plume boundary for all injection target intervals including four injection wells, according to an embodiment.

FIG. 5 illustrates a gas injection rate showing injection automatically and sequentially moving between target intervals, according to an embodiment.

FIG. 6 illustrates a gas injection rate into a target interval by two different injection wells showing a delayed injection period, according to an embodiment.

FIG. 7 illustrates a planar view of a pressure boundary region defined by an inner and outer pressure boundary including a number of injection wells, according to an embodiment.

FIG. 8 illustrates a planar view of a CO2 plume boundary region defined by an inner and outer CO2 plume boundary including a number of injection wells, according to an embodiment.

FIG. 9 illustrates a pressure plume for injection wells within a first injection zone that is within the limits defined by the pressure plume boundary, according to an embodiment.

FIG. 10 illustrates a pressure plume for injection wells within a second injection zone that is within the limits defined by the pressure plume boundary, according to an embodiment.

FIG. 11 illustrates a CO2 plume for injection wells that is within the limits defined by the CO2 plume boundary, according to an embodiment.

FIG. 12 illustrates a flowchart of a method for optimizing carbon dioxide injection volumes, according to an embodiment.

FIG. 13 illustrates a schematic view of a computing system for performing at least a portion of the method(s) described herein, according to an embodiment.

### DETAILED DESCRIPTION

Reference will now be made in detail to embodiments, examples of which are illustrated in the accompanying drawings and figures. In the following detailed description, numerous specific details are set forth in order to provide a thorough understanding of the invention. However, it will be apparent to one of ordinary skill in the art that the invention may be practiced without these specific details. In other instances, well-known methods, procedures, components, circuits, and networks have not been described in detail so as not to unnecessarily obscure aspects of the embodiments.

It will also be understood that, although the terms first, second, etc. may be used herein to describe various elements, these elements should not be limited by these terms. These terms are only used to distinguish one element from another. For example, a first object or step could be termed a second object or step, and, similarly, a second object or step could be termed a first object or step, without departing from the scope of the present disclosure. The first object or step, and the second object or step, are both, objects or steps, respectively, but they are not to be considered the same object or step.

The terminology used in the description herein is for the purpose of describing particular embodiments and is not intended to be limiting. As used in this description and the appended claims, the singular forms “a,” “an” and “the” are intended to include the plural forms as well, unless the context clearly indicates otherwise. It will also be understood that the term “and/or” as used herein refers to and encompasses any possible combinations of one or more of the associated listed items. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Further, as used herein, the term “if” may be construed to mean “when” or “upon” or “in response to determining” or “in response to detecting,” depending on the context.

Attention is now directed to processing procedures, methods, techniques, and workflows that are in accordance with some embodiments. Some operations in the processing procedures, methods, techniques, and workflows disclosed herein may be combined and/or the order of some operations may be changed.

### System Overview

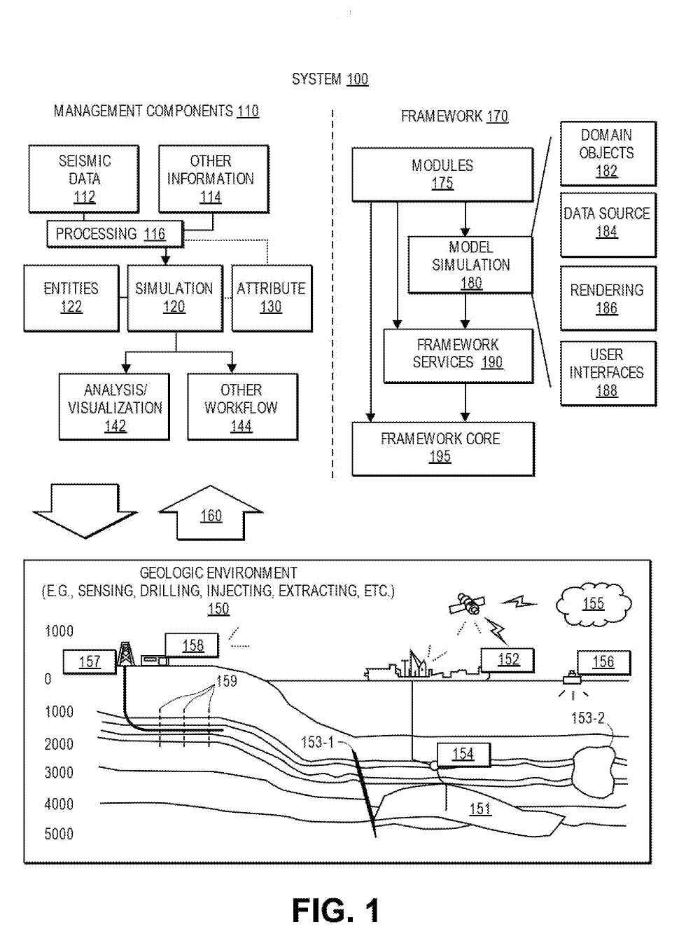

FIG. 1 illustrates an example of a system 100 that includes various management components 110 to manage various aspects of a geologic environment 150 (e.g., an environment that includes a sedimentary basin, a reservoir 151, one or more faults 153-1, one or more geobodies 153-2, etc.). For example, the management components 110 may allow for direct or indirect management of sensing, drilling, injecting, extracting, etc., with respect to the geologic environment 150. In turn, further information about the geologic environment 150 may become available as feedback 160 (e.g., optionally as input to one or more of the management components 110).

In the example of FIG. 1, the management components 110 include a seismic data component 112, an additional information component 114 (e.g., well/logging data), a processing component 116, a simulation component 120, an attribute component 130, an analysis/visualization component 142 and a workflow component 144. In operation, seismic data and other information provided per the components 112 and 114 may be input to the simulation component 120.

In an example embodiment, the simulation component 120 may rely on entities 122. Entities 122 may include earth entities or geological objects such as wells, surfaces, bodies, reservoirs, etc. In the system 100, the entities 122 can include virtual representations of actual physical entities that are reconstructed for purposes of simulation. The entities 122 may include entities based on data acquired via sensing, observation, etc. (e.g., the seismic data 112 and other information 114). An entity may be characterized by one or more properties (e.g., a geometrical pillar grid entity of an earth model may be characterized by a porosity property). Such properties may represent one or more measurements (e.g., acquired data), calculations, etc.

In an example embodiment, the simulation component 120 may operate in conjunction with a software framework such as an object-based framework. In such a framework, entities may include entities based on pre-defined classes to facilitate modeling and simulation. A commercially available example of an object-based framework is the MICROSOFT^{®} .NET^{®} framework (Redmond, Washington), which provides a set of extensible object classes. In the .NET^{®} framework, an object class encapsulates a module of reusable code and associated data structures. Object classes can be used to instantiate object instances for use in by a program, script, etc. For example, borehole classes may define objects for representing boreholes based on well data.

In the example of FIG. 1, the simulation component 120 may process information to conform to one or more attributes specified by the attribute component 130, which may include a library of attributes. Such processing may occur prior to input to the simulation component 120 (e.g., consider the processing component 116). As an example, the simulation component 120 may perform operations on input information based on one or more attributes specified by the attribute component 130. In an example embodiment, the simulation component 120 may construct one or more models of the geologic environment 150, which may be relied on to simulate behavior of the geologic environment 150 (e.g., responsive to one or more acts, whether natural or artificial). In the example of FIG. 1, the analysis/visualization component 142 may allow for interaction with a model or model-based results (e.g., simulation results, etc.). As an example, output from the simulation component 120 may be input to one or more other workflows, as indicated by a workflow component 144.

As an example, the simulation component 120 may include one or more features of a simulator such as the ECLIPSE^{TM} reservoir simulator (SLB, Houston Texas), the INTERSECT^{TM} reservoir simulator (SLB, Houston Texas), etc. As an example, a simulation component, a simulator, etc. may include features to implement one or more meshless techniques (e.g., to solve one or more equations, etc.). As an example, a reservoir or reservoirs may be simulated with respect to one or more enhanced recovery techniques (e.g., consider a thermal process such as SAGD, etc.).

In an example embodiment, the management components 110 may include features of a commercially available framework such as the PETREL^{®} seismic to simulation software framework (SLB, Houston, Texas). The PETREL^{®} framework provides components that allow for optimization of exploration and development operations. The PETREL^{®} framework includes seismic to simulation software components that can output information for use in increasing reservoir performance, for example, by improving asset team productivity. Through use of such a framework, various professionals (e.g., geophysicists, geologists, and reservoir engineers) can develop collaborative workflows and integrate operations to streamline processes. Such a framework may be considered an application and may be considered a data-driven application (e.g., where data is input for purposes of modeling, simulating, etc.).

In an example embodiment, various aspects of the management components 110 may include add-ons or plug-ins that operate according to specifications of a framework environment. For example, a commercially available framework environment marketed as the OCEAN^{®} framework environment (SLB, Houston, Texas) allows for integration of add-ons (or plug-ins) into a PETREL^{®} framework workflow. The OCEAN^{®} framework environment leverages .NET^{®} tools (Microsoft Corporation, Redmond, Washington) and offers stable, user-friendly interfaces for efficient development. In an example embodiment, various components may be implemented as add-ons (or plug-ins) that conform to and operate according to specifications of a framework environment (e.g., according to application programming interface (API) specifications, etc.).

FIG. 1 also shows an example of a framework 170 that includes a model simulation layer 180 along with a framework services layer 190, a framework core layer 195 and a modules layer 175. The framework 170 may include the commercially available OCEAN^{®} framework where the model simulation layer 180 is the commercially available PETREL^{®} model-centric software package that hosts OCEAN^{®} framework applications. In an example embodiment, the PETREL^{®} software may be considered a data-driven application. The PETREL^{®} software can include a framework for model building and visualization.

As an example, a framework may include features for implementing one or more mesh generation techniques. For example, a framework may include an input component for receipt of information from interpretation of seismic data, one or more attributes based at least in part on seismic data, log data, image data, etc. Such a framework may include a mesh generation component that processes input information, optionally in conjunction with other information, to generate a mesh.

In the example of FIG. 1, the model simulation layer 180 may provide domain objects 182, act as a data source 184, provide for rendering 186 and provide for various user interfaces 188. Rendering 186 may provide a graphical environment in which applications can display their data while the user interfaces 188 may provide a common look and feel for application user interface components.

As an example, the domain objects 182 can include entity objects, property objects and optionally other objects. Entity objects may be used to geometrically represent wells, surfaces, bodies, reservoirs, etc., while property objects may be used to provide property values as well as data versions and display parameters. For example, an entity object may represent a well where a property object provides log information as well as version information and display information (e.g., to display the well as part of a model).

In the example of FIG. 1, data may be stored in one or more data sources (or data stores, generally physical data storage devices), which may be at the same or different physical sites and accessible via one or more networks. The model simulation layer 180 may be configured to model projects. As such, a particular project may be stored where stored project information may include inputs, models, results and cases. Thus, upon completion of a modeling session, a user may store a project. At a later time, the project can be accessed and restored using the model simulation layer 180, which can recreate instances of the relevant domain objects.

In the example of FIG. 1, the geologic environment 150 may include layers (e.g., stratification) that include a reservoir 151 and one or more other features such as the fault 153-1, the geobody 153-2, etc. As an example, the geologic environment 150 may be outfitted with any of a variety of sensors, detectors, actuators, etc. For example, equipment 152 may include communication circuitry to receive and to transmit information with respect to one or more networks 155. Such information may include information associated with downhole equipment 154, which may be equipment to acquire information, to assist with resource recovery, etc. Other equipment 156 may be located remote from a well site and include sensing, detecting, emitting or other circuitry. Such equipment may include storage and communication circuitry to store and to communicate data, instructions, etc. As an example, one or more satellites may be provided for purposes of communications, data acquisition, etc. For example, FIG. 1 shows a satellite in communication with the network 155 that may be configured for communications, noting that the satellite may additionally or instead include circuitry for imagery (e.g., spatial, spectral, temporal, radiometric, etc.).

FIG. 1 also shows the geologic environment 150 as optionally including equipment 157 and 158 associated with a well that includes a substantially horizontal portion that may intersect with one or more fractures 159. For example, consider a well in a shale formation that may include natural fractures, artificial fractures (e.g., hydraulic fractures) or a combination of natural and artificial fractures. As an example, a well may be drilled for a reservoir that is laterally extensive. In such an example, lateral variations in properties, stresses, etc. may exist where an assessment of such variations may assist with planning, operations, etc. to develop a laterally extensive reservoir (e.g., via fracturing, injecting, extracting, etc.). As an example, the equipment 157 and/or 158 may include components, a system, systems, etc. for fracturing, seismic sensing, analysis of seismic data, assessment of one or more fractures, etc.

As mentioned, the system 100 may be used to perform one or more workflows. A workflow may be a process that includes a number of worksteps. A workstep may operate on data, for example, to create new data, to update existing data, etc. As an example, a workstep may operate on one or more inputs and create one or more results, for example, based on one or more algorithms. As an example, a system may include a workflow editor for creation, editing, executing, etc. of a workflow. In such an example, the workflow editor may provide for selection of one or more pre-defined worksteps, one or more customized worksteps, etc. As an example, a workflow may be a workflow implementable in the PETREL^{®} software, for example, that operates on seismic data, seismic attribute(s), etc. As an example, a workflow may be a process implementable in the OCEAN^{®} framework. As an example, a workflow may include one or more worksteps that access a module such as a plug-in (e.g., external executable code, etc.).

A network architecture for drilling operations typically involves a multi-layered setup designed to handle the complexities of rig environments, as shown in FIG. 1. The infrastructure may be segmented into distinct network zones, such as an information technology (IT) network, an operational technology (OT) network, and a rig network, to ensure security and manageability.

The IT network may include centralized support and monitoring systems, such as the Service Provider Central Support Network, which interacts with the rig networks via secure communication channels. The OT network may operate within a more restrictive environment, managing essential control systems and acquisition networks, including surface and downhole data acquisition devices. Each network segment is further isolated using firewalls and hypervisor technologies, enabling network segmentation and perimeter security.

The rig network connects often used edge devices, such as drilling control units, acquisition systems, and other wellsite equipment which perform various automation and data processing tasks. These edge devices often operate with limited bandwidth, making it challenging to transmit large amounts of data in real time. Therefore, a robust strategy for monitoring and data collection is preferred to ensure efficient operation without overwhelming the network.

### Method for Optimizing Carbon Dioxide Sequestration

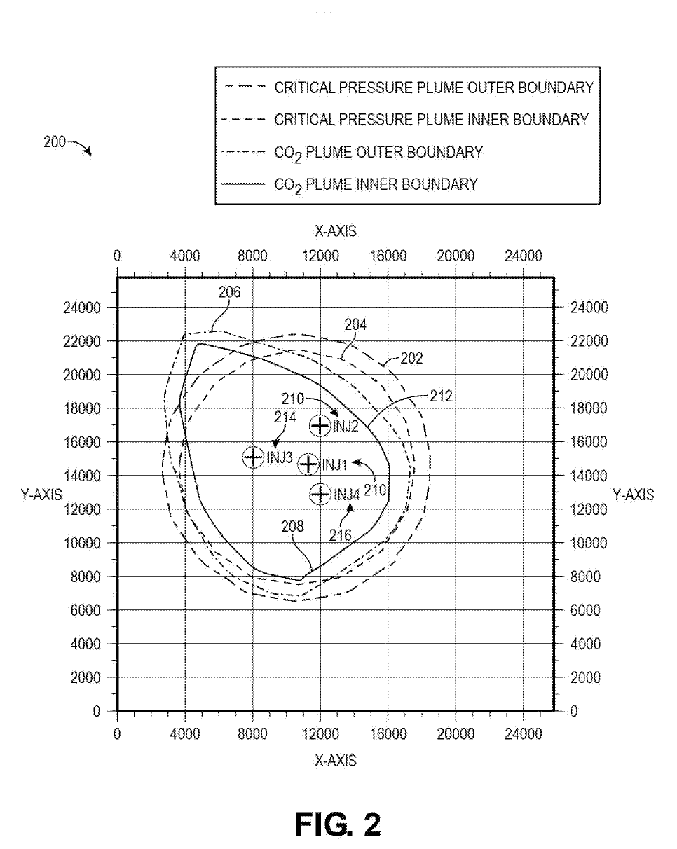

According to certain embodiments, a Python script (herein known as the Optimizer) may be used to constrain CO2 injection volumes into a reservoir or injection zone such that the pressure plume and/or the CO2 plume post injection is not outside a defined boundary, the defined boundary being an initial input into the Optimizer along with an injection rate limit and a bottom hole pressure limit. FIG. 2 shows an aerial view of a defined boundary 200 which includes outer and inner boundaries of a pressure plume 202, 204 and a CO2 plume 206, 208, respectively, along with a plurality of injection wells 210-216 that are disposed or contained within the defined boundary 200. Without the Optimizer, multiple optimization runs, for multiple of tens of runs, would be performed to determine the duration of injection such that the CO2 plume post injection or the pressure profile does not extend beyond a defined area of interest.

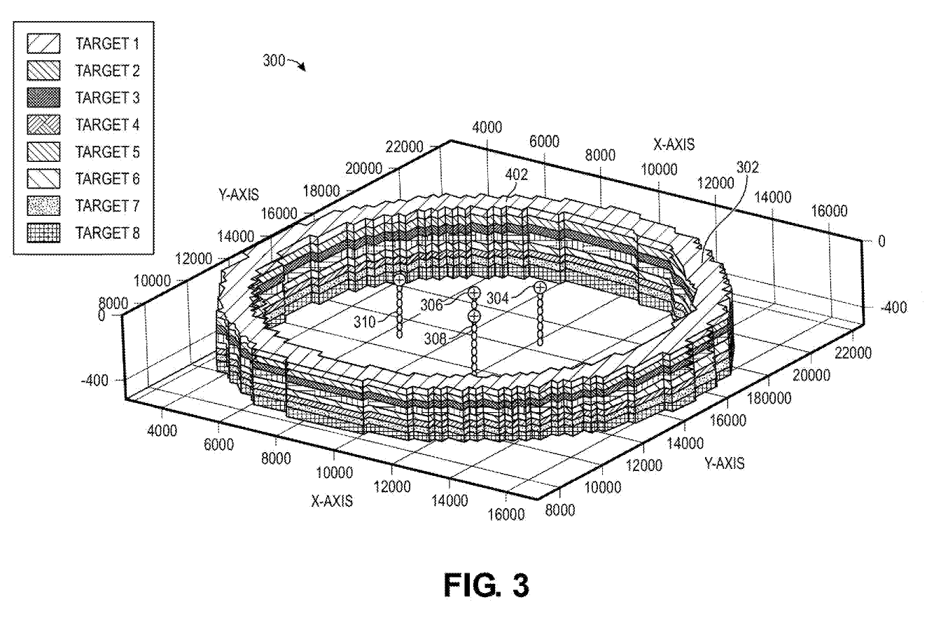

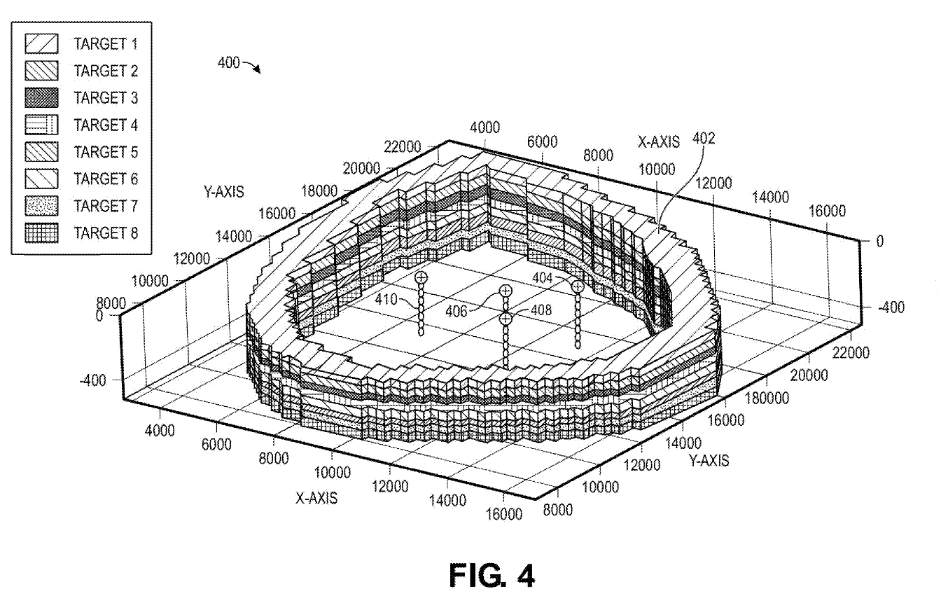

In certain embodiments, when planning for CO2 sequestration, an area of review (AOR) may be defined as the larger of either the CO2 plume or the pressure plume. Operators may optimize injection volumes so that the AOR does not encroach on lease boundaries or other well penetrations, while simultaneously maximizing injected volumes. The current disclosure may use the Optimizer to provide an approach to automatically maximize injection volumes during a numerical simulation for a given AOR without the need for manual optimization or multiple sensitivity simulations. This approach may reduce the time needed for the CO2 optimization workflow and thereby reduce simulation costs by cutting down on the number of needed simulation runs from double digits to just two or three simulation runs. In certain embodiments, there can be several wells injecting CO2 at different phases of the injection, either as single injection wells or as combinations of multiple injection wells within the AOR or within any number of discrete zones or sub-areas within the AOR. For example, as seen in FIG. 3, an AOR 300 may be defined by the pressure boundary 302 for a plurality of target intervals for four injection wells 304-310 and their respective perforations, while as seen in FIG. 4, an AOR 400 may be defined by the CO2 plume boundary 402 for a plurality of target intervals for four injection wells 404-410 and their respective perforations.

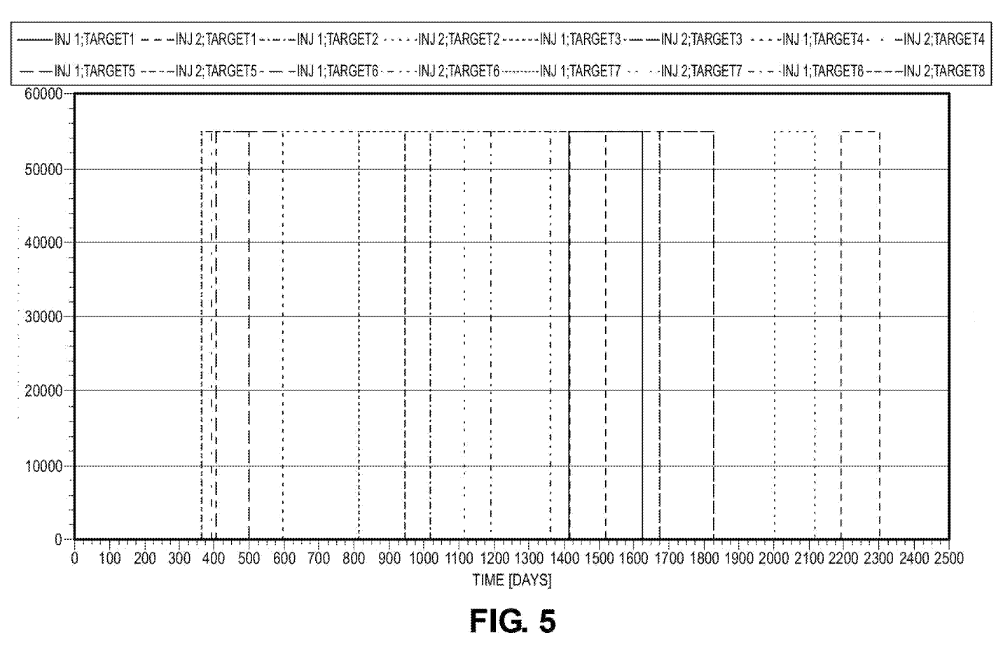

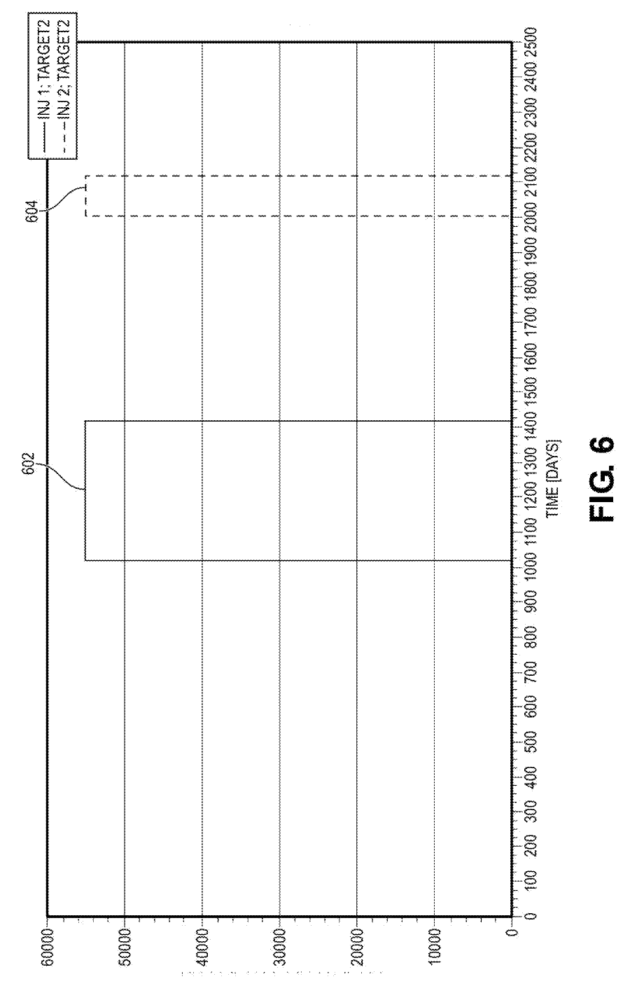

According to certain embodiments, a numerical simulator with Python extensibility may be programmed to compute the AOR 300, 400 as the simulation runs at timestep resolution. Injection of CO2 may stop or cease once it has been detected that the AOR boundary 302, 402 has been exceeded in any direction for a specific injection zone or sub-area of the AOR 300, 400. Injection of CO2 may then automatically continue into a second or further CO2 injection zone. After a predetermined wait period, either because there is more pore space for CO2 to be injected or the related pressure has declined within the injection zone, one or more of the injection wells in the first injection zone may be reopened. In certain embodiments, new or additional injection wells within the first or further injection zone which may already have an amount CO2 injected therein may recommence injection to ensure that a maximum volume of CO2 may be injected within a specific injection zone within the larger AOR. For example, as seen in FIG. 5, the method may alternate injection procedures between a first injection well and a second injection well, each over a number of target intervals which may vary in duration so as to optimize an overall sequestration process. In certain embodiments, a target interval may include applying a CO2 injection rate for a first injection well 602 and a second injection well 604, each injection well 602, 604 being activated over different durations of time as seen in FIG. 6.

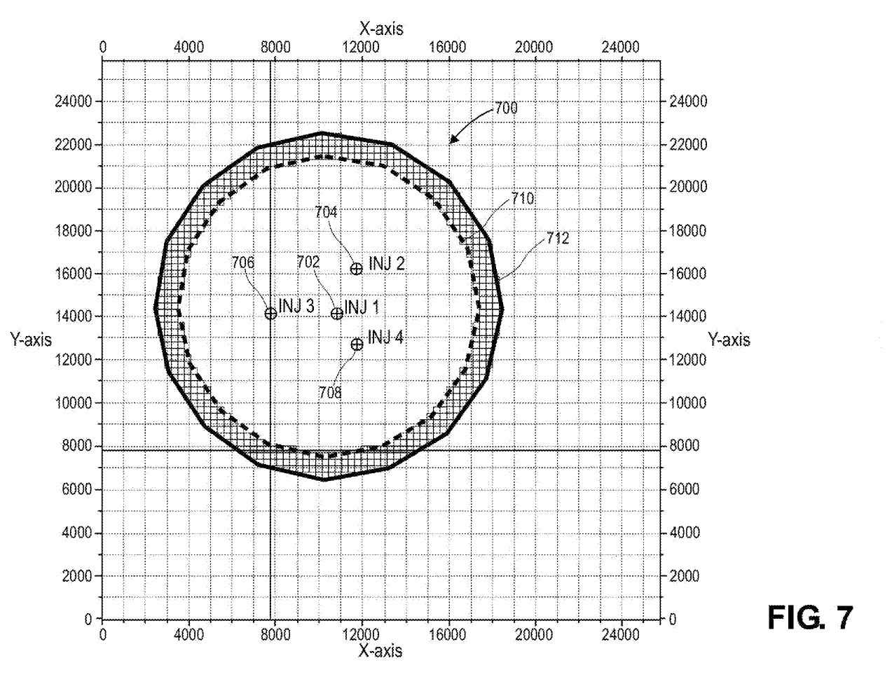

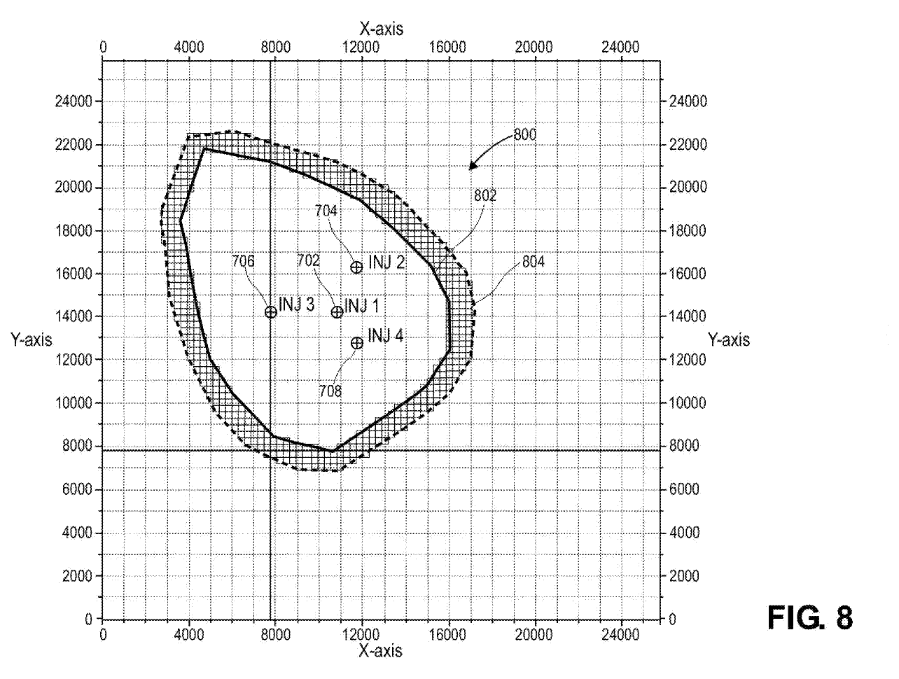

According to certain embodiments, a reservoir model for CO2 storage may be built with an AOR boundary being a required input. In certain embodiments, the AOR boundary may be different for different injection zones, as well for different pressure fronts or CO2 plume fronts. For example, FIG. 7 shows four injection wells 702-708 with an AOR 700 defined by a related inner 710 and an outer 712 pressure boundary, while FIG. 8 shows an AOR 800 defined by an inner 802 and an outer 804 CO2 plume boundary for the same four injection wells 702-708.

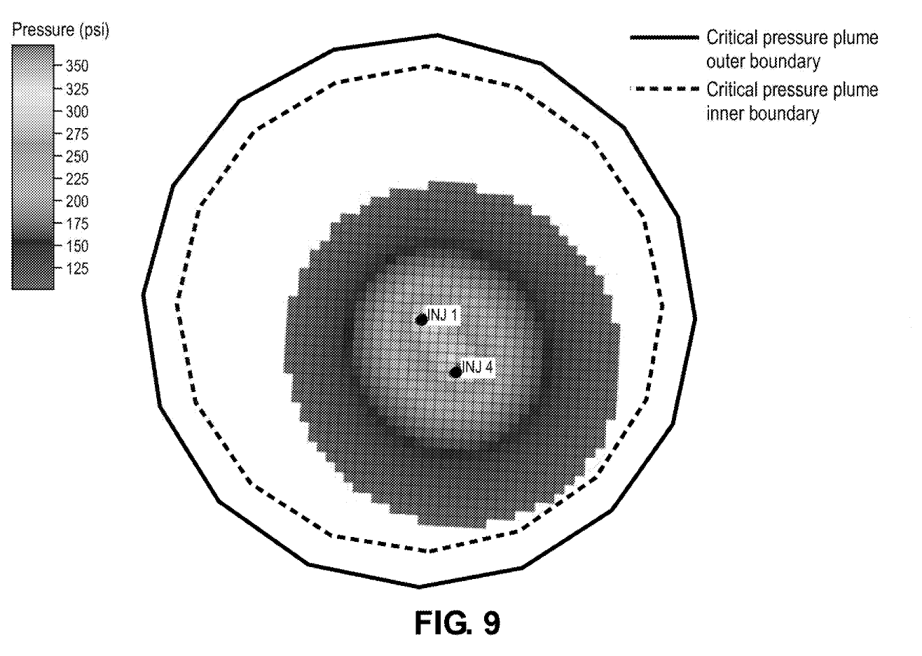

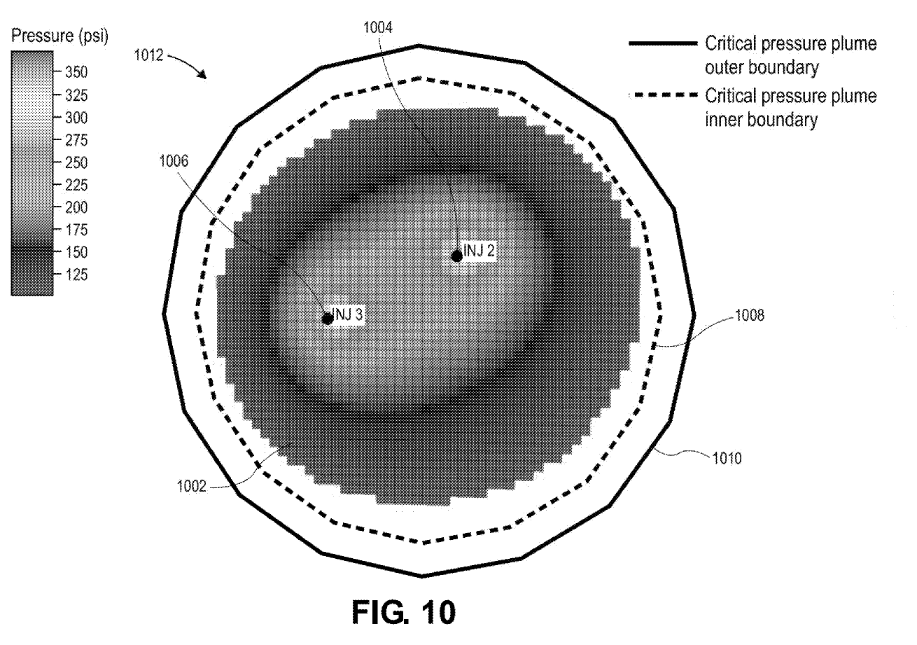

According to certain embodiments, for zones whose AOR is defined by the pressure plume, the optimization algorithm may be effective at defining the maximum volume of CO2 to be injected without the AOR extending beyond the input boundary in a single simulation run. FIG. 9 illustrates a pressure plume 902 for Phase 1 or injection wells 904, 906 within a first injection zone 912 that are within limits defined by the pressure plume boundary, specifically a pressure plume inner boundary 908 and a pressure plume outer boundary 910, while FIG. 10 illustrates a second pressure plume 1002 for Phase 2 or injection wells 1004, 1006 within a second or further injection zone 1012 that are within limits defined by the pressure plume boundary, namely a pressure plume inner boundary 1008 and a pressure plume outer boundary 1010 which may correspond to the second or further injection zone 1012.

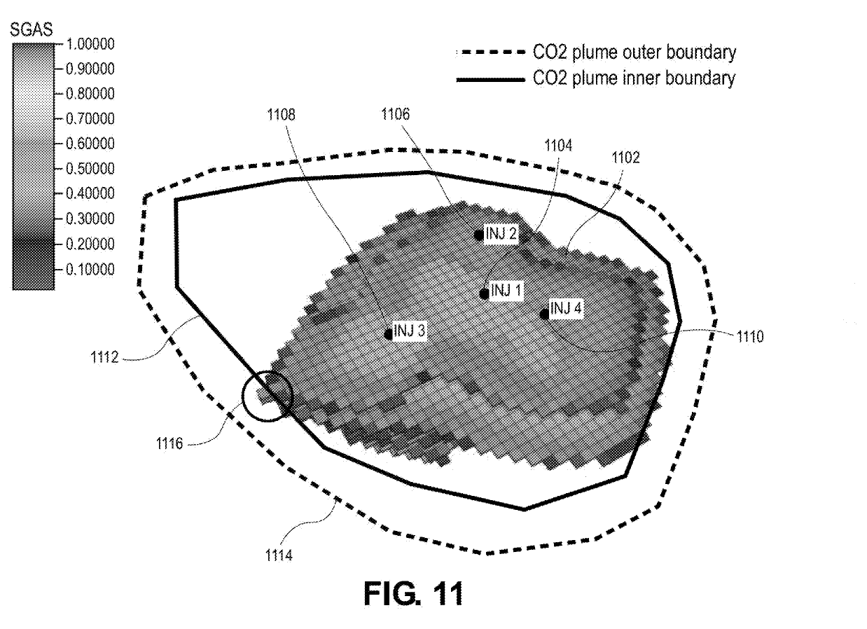

According to certain embodiments, for an AOR that may be defined by the CO2 plume, the Optimizer may not account for the growth or migration of the plume during the shut-in time. However, the distance that the plume may exceed the input boundary can be used to tighten the boundary and rerun the simulation with the optimization algorithm. Hence, a plume-limited AOR can be optimized in as little as two simulations, significantly improving over the manual approach. FIG. 11 illustrates a CO2 plume 1102 for injection wells 1104-1110 that has migrated past a CO2 plume inner boundary 1112 at a penetration point 1116, but which is still within the limits defined by the CO2 plume outer boundary 1114.

According to certain embodiments, the Optimizer may be an improvement over manual optimization of a traditional CO2 injection workflow. In certain embodiments, the method may provide a more precise result than a series of sensitivity simulations that require discrete parameter selection. Additionally, the method may reduce the number of simulation runs, and hence indirectly reduce simulation costs, that are needed to achieve the optimized injection volumes and injection duration. Furthermore, the method may be extended for AORs with different numbers of injection wells, different number of injection phases, different combinations of injection wells that are in different phases, or other factors which increase the complexity of the injection strategy while significantly reducing the time to achieve an optimized result. The method may be useful for optimizing multi-target injections into leases of any size. In certain embodiments, the Optimizer of the current method may be incorporated into a simulation model with negligible impact on the elapsed time of a simulation run.

### Exemplary Method

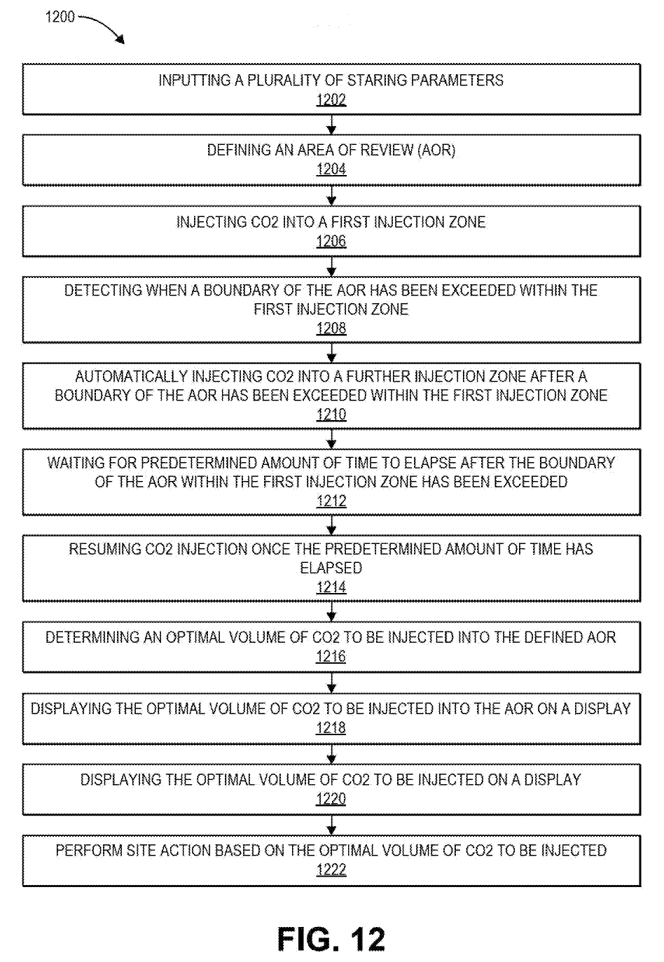

FIG. 12 is a flowchart illustrating a method 1200 for optimizing carbon dioxide injection volumes, according to an embodiment. An illustrative order of the method 1200 is provided below; however, one or more portions of the method 1200 may be performed in a different order, simultaneously, repeated, or omitted. At least a portion of the method 1200 may be performed using a computing system. The method 1200 may include receiving or inputting a plurality of starting parameters, as at 1202. In certain embodiments, the starting parameters include but are not limited to an injection rate limit and a bottom hole pressure limit.

The method 1200 may include defining an area of review (AOR) that is related to a CO2 sequestration site based on the starting parameters, as at 1204. In certain embodiments, the AOR may be either the larger of a CO2 plume or a pressure plume, or both, that is centered around at least one injection well. Defining the AOR may include defining an outer boundary of the AOR and an inner boundary of the AOR. The inner boundary may be defined within the outer boundary.

In certain embodiments, the method 1200 includes injecting CO2 into the defined AOR, as at 1206. In certain embodiments, the AOR may include one or more injection zones, with each injection zone having one or more injection wells. Injecting may include generating or transmitting a signal that recommends, instructs, or causes the CO2 to be physically injected. In another embodiment, injecting may include physically injecting the CO2.

In certain embodiments, the method 1200 may include detecting when a boundary of the AOR has been exceeded by the injected CO2, as at 1208. Detecting when the boundary of the AOR has been exceeded by the injected CO2 may include detecting when the inner boundary of the AOR has been exceeded.

In certain embodiments, the method 1200 may include adjusting a flow of CO2 injected into the AOR when the boundary of the AOR has been exceeded by the injected CO2, as at 1210. Adjusting may include generating or transmitting a signal that recommends, instructs, or causes the flow to be physically adjusted. In another embodiment, adjusting may include physically adjusting the flow. Adjusting the flow of CO2 injected into the AOR when the boundary of the AOR has been exceeded may include stopping a flow of CO2 injected into a first injection zone of the AOR, waiting for a predetermined amount of time to elapse when the boundary of the AOR has been exceeded, and resuming CO2 injection within the first injection zone once the predetermined amount of time has elapsed. In certain embodiments, adjusting the flow of injected CO2 may include automatically injecting CO2 into a further injection zone within the AOR when the flow of CO2 injected into the first injection zone is stopped. In certain embodiments, resuming CO2 injection within the first injection zone may include injecting CO2 into the first injection zone through a first plurality of injection wells and injecting CO2 into the first injection zone through a second plurality of injection wells. The second plurality of injection wells may be separated from the first plurality of injection wells within the first injection zone. It should be noted that in certain embodiments it may be possible to have more than two separate or distinct pluralities of injection wells. For example, if there are ten injection wells within an AOR, and they are injected in groups of two, then there may be five different pluralities of injection wells that may be operated simultaneously, sequentially, or in a predetermined combination. In certain embodiments, resuming CO2 injection within the first injection zone may also include compensating for migration of CO2 within the first injection zone or within the further injection zone. In certain embodiments, adjusting the flow of CO2 injected into the AOR when the boundary of the AOR has been exceeded by the injected CO2 may include sequentially injecting CO2 into a first injection zone and a further injection zone within the AOR.

According to certain embodiments, the method 1200 may also include stopping CO2 injection in a first injection well within a first injection zone when the boundary of the AOR has been exceeded by the injected CO2 within the first injection zone, as at 1212. In certain embodiments, CO2 injection in at least one further injection well within the first injection zone may continue when CO2 injection in the first injection well has stopped. Stopping may include generating or transmitting a signal that recommends, instructs, or causes the CO2 injection to be physically stopped. In another embodiment, stopping may include physically stopping the CO2 injection.

According to certain embodiments, the method 1200 may also include determining an optimal volume of CO2 to be injected into the AOR based on the adjusted flow, as at 1214. The optimal volume of CO2 may be based on a pressure plume of the CO2 injected into the AOR or on a CO2 plume of the CO2 injected into the AOR.

According to certain embodiments, the method 1200 may also include revising the optimal volume of CO2 to be injected according to a detected distance that the CO2 plume has migrated past the boundary of the AOR, as at 1216.

According to certain embodiments, the method 1200 may also include displaying the optimal volume of CO2 to be injected into the AOR on a display, as at 1218. Displaying may include generating or transmitting a signal that recommends, instructs, or causes the optimal volume of CO2 to be physically displayed. In another embodiment, displaying may include physically displaying the optimal volume of CO2 to be injected into the AOR.

According to certain embodiments, the method 1200 may also include performing a site action based on the optimal volume of CO2 to be injected into the AOR, as at 1220. Performing the site action may include generating or transmitting a signal that instructs or causes an action to occur. The action may include a physical action. The physical action may include selecting where to drill a wellbore in a subsurface formation, where to complete the wellbore within an injection zone, varying a trajectory of the wellbore, varying a rate or concentration of CO2 being introduced into the wellbore, determining a duration of injection, or a combination thereof.

### Exemplary Computing System

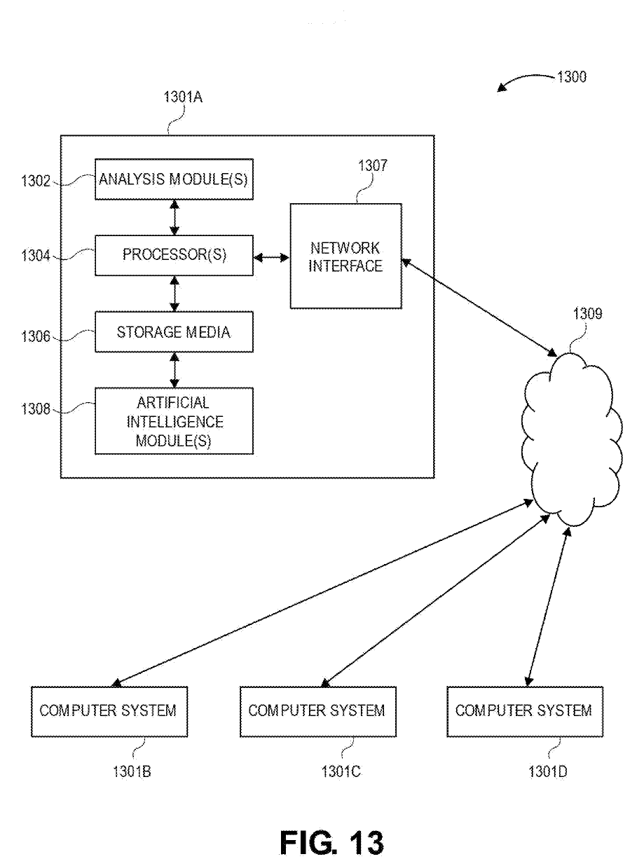

In some embodiments, the methods of the present disclosure may be executed by a computing system. FIG. 13 illustrates an example of such a computing system 1300, in accordance with some embodiments. The computing system 1300 may include a computer or computer system 1301A, which may be an individual computer system 1301A or an arrangement of distributed computer systems. The computer system 1301A includes one or more analysis modules 1302 that are configured to perform various tasks according to some embodiments, such as one or more methods disclosed herein. To perform these various tasks, the analysis module 1302 executes independently, or in coordination with, one or more processors 1304, which is (or are) connected to one or more storage media 1306. The processor(s) 1304 is (or are) also connected to a network interface 1307 to allow the computer system 1301A to communicate over a data network 1309 with one or more additional computer systems and/or computing systems, such as 1301B, 1301C, and/or 1301D (note that computer systems 1301B, 1301C and/or 1301D may or may not share the same architecture as computer system 1301A, and may be located in different physical locations, e.g., computer systems 1301A and 1301B may be located in a processing facility, while in communication with one or more computer systems such as 1301C and/or 1301D that are located in one or more data centers, and/or located in varying countries on different continents).

A processor may include a microprocessor, microcontroller, processor module or subsystem, programmable integrated circuit, programmable gate array, or another control or computing device.

The storage media 1306 may be implemented as one or more computer-readable or machine-readable storage media. Note that while in the example embodiment of FIG. 13 storage media 1306 is depicted as within computer system 1301A, in some embodiments, storage media 1306 may be distributed within and/or across multiple internal and/or external enclosures of computing system 1301A and/or additional computing systems. Storage media 1306 may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories, magnetic disks such as fixed, floppy and removable disks, other magnetic media including tape, optical media such as compact disks (CDs) or digital video disks (DVDs), BLURAY^{®} disks, or other types of optical storage, or other types of storage devices. Note that the instructions discussed above may be provided on one computer-readable or machine-readable storage medium, or may be provided on multiple computer-readable or machine-readable storage media distributed in a large system having possibly plural nodes. Such computer-readable or machine-readable storage medium or media is (are) considered to be part of an article (or article of manufacture). An article or article of manufacture may refer to any manufactured single component or multiple components. The storage medium or media may be located either in the machine running the machine-readable instructions, or located at a remote site from which machine-readable instructions may be downloaded over a network for execution.

It should be appreciated that computing system 1300 is merely one example of a computing system, and that computing system 1300 may have more or fewer components than shown, may combine additional components not depicted in the example embodiment of FIG. 13, and/or computing system 1300 may have a different configuration or arrangement of the components depicted in FIG. 13. The various components shown in FIG. 13 may be implemented in hardware, software, or a combination of both hardware and software, including one or more signal processing and/or application specific integrated circuits.

Further, the steps in the processing methods described herein may be implemented by running one or more functional modules in information processing apparatus such as general purpose processors or application specific chips, such as ASICs, FPGAs, PLDs, or other appropriate devices. These modules, combinations of these modules, and/or their combination with general hardware are included within the scope of the present disclosure.

Computational interpretations, models, and/or other interpretation aids may be refined in an iterative fashion; this concept is applicable to the methods discussed herein. This may include use of feedback loops executed on an algorithmic basis, such as at a computing device (e.g., computing system 1300, FIG. 13), and/or through manual control by a user who may make determinations regarding whether a given step, action, template, model, or set of curves has become sufficiently accurate for the evaluation of the risk index.

The foregoing description, for purpose of explanation, has been described with reference to specific embodiments. However, the illustrative discussions above are not intended to be exhaustive or limiting to the precise forms disclosed. Many modifications and variations are possible in view of the above teachings. Moreover, the order in which the elements of the methods described herein are illustrated and described may be re-arranged, and/or two or more elements may occur simultaneously. The embodiments were chosen and described in order to best explain the principles of the disclosure and its practical applications, to thereby enable others skilled in the art to best utilize the disclosed embodiments and various embodiments with various modifications as are suited to the particular use contemplated.

What is claimed is:

1. A method for optimizing carbon dioxide injection volumes, the method comprising:
inputting a plurality of starting parameters;
defining an area of review (AOR) related to a CO2 sequestration site based on the starting parameters;
injecting CO2 into the defined AOR;
detecting when a boundary of the AOR has been exceeded by the injected CO2; and
adjusting a flow of CO2 injected into the AOR when the boundary of the AOR has been exceeded by the injected CO2.

2. The method of claim 1, further comprising determining a volume of CO2 to be injected into the AOR based on the adjusted flow.

3. The method of claim 1, wherein adjusting the flow of CO2 injected into the AOR when the boundary of the AOR has been exceeded comprises:
stopping a flow of CO2 injected into a first injection zone of the AOR;
waiting for a predetermined amount of time to elapse when the boundary of the AOR has been exceeded; and
resuming CO2 injection within the first injection zone once the predetermined amount of time has elapsed.

4. The method of claim 3, further comprising automatically injecting CO2 into a further injection zone within the AOR when the flow of CO2 injected into the first injection zone is stopped.

5. The method of claim 3, wherein resuming CO2 injection within the first injection zone comprises injecting CO2 into the first injection zone through a first plurality of injection wells.

6. The method of claim 5, further comprising injecting CO2 into the first injection zone through a second plurality of injection wells, wherein the second plurality of injection wells are separated from the first plurality of injection wells within the first injection zone.

7. The method of claim 4, wherein resuming CO2 injection within the first injection zone comprises compensating for migration of CO2 within the first injection zone or within the further injection zone.

8. The method of claim 1, further comprising stopping CO2 injection in a first injection well within a first injection zone when the boundary of the AOR has been exceeded by the injected CO2 within the first injection zone.

9. The method of claim 7, further comprising continuing CO2 injection in at least one further injection well within the first injection zone when CO2 injection in the first injection well has stopped.

10. The method of claim 1, further comprising performing a site action based on the volume of CO2 to be injected into the AOR.

11. A computing system, comprising:
one or more processors; and
a memory system comprising one or more non-transitory computer-readable media storing instructions that, when executed by at least one of the one or more processors, cause the computing system to perform operations, the operations comprising:
inputting a plurality of starting parameters;
defining an area of review (AOR) related to a CO2 sequestration site based on the starting parameters;
injecting CO2 into the defined AOR;
detecting when a boundary of the AOR has been exceeded by the injected CO2; and
adjusting a flow of CO2 injected into the AOR when the boundary of the AOR has been exceeded by the injected CO2.

12. The computing system of claim 11, wherein the operations further comprise determining a volume of CO2 to be injected into the AOR based on the adjusted flow.

13. The computing system of claim 11, wherein adjusting the flow of CO2 injected into the AOR when the boundary of the AOR has been exceeded by the injected CO2 comprises sequentially injecting CO2 into a first injection zone and a further injection zone within the AOR.

14. The computing system of claim 11, wherein defining the AOR comprises defining an outer boundary of the AOR and an inner boundary of the AOR, wherein the inner boundary is defined within the outer boundary.

15. The computing system of claim 14, wherein detecting when the boundary of the AOR has been exceeded by the injected CO2 comprises detecting when the inner boundary of the AOR has been exceeded.

16. The computing system of claim 11, wherein defining the AOR comprises defining the AOR as the larger of a CO2 plume or a pressure plume centered around at least one injection well.

17. The computing system of claim 11, wherein defining the AOR comprises defining the AOR as a combination of a CO2 plume and a pressure plume centered around at least one injection well.

18. The computing system of claim 17, wherein the operations further comprise revising the volume of CO2 to be injected according to a detected distance that the CO2 plume has migrated past the boundary of the AOR.

19. The computing system of claim 11, wherein the operations further comprise performing a site action based on the volume of CO2 to be injected into the AOR, wherein performing the site action comprises generating or transmitting a signal that instructs or causes an action to occur, wherein the action comprises a physical action, and wherein the physical action comprises selecting where to drill a wellbore in a subsurface formation, where to complete the wellbore within an injection zone, varying a trajectory of the wellbore, varying a rate or concentration of CO2 being introduced into the wellbore, determining a duration of injection, displaying the volume of CO2 to be injected into the AOR on a screen, or a combination thereof.

20. A non-transitory computer-readable medium storing instructions that, when executed by one or more processors of a computing system, cause the computing system to perform operations, the operations comprising:
inputting a plurality of starting parameters;
defining an area of review (AOR) related to a CO2 sequestration site based on the starting parameters;
injecting CO2 into the defined AOR;
detecting when a boundary of the AOR has been exceeded by the injected CO2; and
adjusting a flow of CO2 injected into the AOR when the boundary of the AOR has been exceeded by the injected CO2.
